(19) United States
(12) Patent Application Publication
(10) Pub. No.: US 2012/0253712 A1
(43) Pub. Date: Oct. 4, 2012

(54) POWER CONSUMPTION CALCULATION METHOD, POWER CONSUMPTION CALCULATION APPARATUS, AND NON-TRANSITORY COMPUTER-READBLE MEDIUM STORING POWER CONSUMPTION CALCULATION PROGRAM

(75) Inventors: Itsumi SUGIYAMA, Kawasaki (JP); Yukihito Kawabe, Kawasaki (JP)

(73) Assignee: FUJITSU LIMITED, Kawasaki-shi (JP)

(21) Appl. No.: 13/495,576

(22) Filed: Jun. 13, 2012

Related U.S. Application Data
(63) Continuation of application No. PCT/JP2009/006998, filed on Dec. 18, 2009.

(51) Int. Cl. G06F 19/00

(52) U.S. Cl. 702/61

(57) ABSTRACT

A method of calculating power consumption of an integrated circuit based on circuit information representing an internal configuration of each circuit and connection-between-circuits information is performed by a computer. The method includes acquiring transition information about input and output signals of the circuit by performing logical analysis, on the assumption of no propagation delay between the circuits, based on input pattern information of the integrated circuit, the connection-between-circuits information, and logical model information about the circuit, extracting from transition patterns of the input signal, a transition pattern causing a glitch in the output signal based on the logical model information, reflecting the glitch in the transition information about the output signal responsive to the input signal having the extracted transition pattern among the acquired transition information, and calculating, by the computer, the power consumption of the integrated circuit based on the transition information in which the glitch is reflected.

### CROSS-REFERENCE TO RELATED APPLICATION

This is a continuation of Application PCT/JP2009/006998, filed on Dec. 18, 2009, the entire contents of which are incorporated herein by reference.

### FIELD

The embodiments discussed herein are related to a method for calculating a power consumption of an integrated circuit, and a power consumption calculation apparatus, and a power consumption calculation program.

### BACKGROUND

Power consumption of integrated circuits including large scale integrated circuits (LSIs) is increased in accordance with an increase in size of the integrated circuits. The voltage level supplied to each circuit in each integrated circuit becomes unstable with the increasing power consumption of the integrated circuit. The state in which the voltage level is unstable in the integrated circuit can cause malfunction of the integrated circuit. Accordingly, it is desirable to calculate the power consumption of the integrated circuit from circuit data and design conditions and to design the integrated circuit so as to stably supply power to each internal circuit in accordance with the calculated power consumption.

Methods of analyzing the power consumption of the integrated circuit in design of the integrated circuit include event-driven analysis. In the event-driven analysis, multiple cells composing the integrated circuit are modeled in a transistor level to analyze the power consumption of the integrated circuit. The cells are circuit macros serving as circuit blocks composing the integrated circuit. The cells can be modeled in the transistor level, which is a minimum element in a switching operation, to more accurately calculate the delay in timing of input and output signals in each cell and a variation with time of the power consumption. In addition, the conditions of input signals into the integrated circuit can be made close to those of input signals when the circuit is actually operating to analyze the power consumption of the integrated circuit in a state closer to the actual operation.

The power consumption of the integrated circuit is not fixed but is varied with the operating conditions of each cell composing the integrated circuit and/or the availability ratio of the transistors. Accordingly, it is desired to continue the analysis of the integrated circuit before various operation patterns appear in order to more accurately analyze the maximum power consumption of the integrated circuit. In addition, the analysis of each cell in the transistor level largely increases the model of the entire integrated circuit in size to largely increase the calculation time.

In contrast to the event-driven analysis described above, cycle-based analysis is also used. In the cycle-based analysis, the analysis is performed on the assumption that no delay occurs in the timing of input and output signals in each cell. The assumption that no delay occurs in each cell causes the signal state to be varied only once in each clock cycle. As a result, it is possible to analyze the maximum power consumption of the integrated circuit in one clock cycle.

However, the assumption that no delay occurs in each cell inhibits an increase in the power consumption caused by an occurrence of a glitch from being considered. The glitch is caused by shift (skew) of the timing when multiple input signals arrive at one cell. Since it is assumed that no delay occurs in each cell in the cycle-based analysis, the glitch that may actually occur is not considered.

Japanese Laid-open Patent Publication No. 2001-4675 and Japanese Laid-open Patent Publication No. 2001-265847 disclose technologies concerning the calculation of the power consumption of the integrated circuit considering the occurrence of the glitch.

### SUMMARY

According to an aspect of the invention, a method of calculating power consumption of an integrated circuit on the basis of circuit information representing an internal configuration of each circuit included in the integrated circuit and connection-between-circuits information representing connection between the circuits, the method includes acquiring, by a computer, transition information about an input signal and an output signal of the circuit by performing logical analysis, on the assumption that no propagation delay occurs between the circuits, on the basis of input pattern information including an input signal pattern of the integrated circuit, the connection-between-circuits information, and logical model information about the circuit, extracting, by the computer, from transition patterns of the input signal of the circuit, a transition pattern causing a glitch in the output signal of the circuit on the basis of the logical model information about the circuit, reflecting, by the computer, the glitch in the transition information about the output signal of the circuit responsive to the input signal having the extracted transition pattern among the acquired transition information, and calculating, by the computer, the power consumption of the integrated circuit on the basis of the transition information in which the glitch is reflected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the entire flow of calculating power consumption according to an embodiment;

FIG. 2 is an exemplary block diagram of a power consumption calculating apparatus calculating the power consumption of an integrated circuit;

FIG. 3A is an exemplary circuit diagram of a circuit for which the power consumption is to be calculated, FIG. 3B illustrates an exemplary result of event-driven analysis, and FIG. 3C illustrates an exemplary result of cycle-based analysis;

FIG. 4 is a flow chart illustrating an exemplary process of generating a glitch occurring condition;

FIG. 5 is an exemplary diagram that defines the glitch occurring condition;

FIG. 6 is a flow chart illustrating an exemplary process of converting transition information;

FIG. 7A illustrates an exemplary transition pattern before the transition information is converted and FIG. 7B illustrates an exemplary transition pattern after the transition information is converted;

FIG. 8 is an exemplary diagram that defines cell power information;

FIG. 9 is an exemplary diagram that defines wiring-between-cells information;

FIG. 10 is a flow chart illustrating an exemplary process of converting the transition information;

FIG. 11A illustrates an exemplary transition pattern before the transition information is converted, FIG. 11B illustrates an exemplary transition pattern after the glitch is inserted in the transition information conversion, and FIG. 11C illustrates an exemplary transition pattern after the transition pattern is updated;

FIG. 12 is an exemplary circuit diagram of a circuit for which the power consumption is to be calculated;

FIG. 13 is a flow chart illustrating an exemplary process of generating a glitch propagation condition;

FIG. 14 is an exemplary diagram that defines a glitch occurring condition;

FIG. 15 is a flow chart illustrating an exemplary process of converting the transition information; and

FIG. 16A illustrates an exemplary transition pattern before the glitch is inserted, FIG. 16B illustrates an exemplary transition pattern after the glitch is inserted, and FIG. 16C illustrates an exemplary transition pattern after the glitch is propagated.

### DESCRIPTION OF EMBODIMENTS

Embodiments will herein be described with reference to the attached drawings. The embodiments provide an apparatus, a method, and a program of calculating the power consumption of an integrated circuit considering an occurrence of a glitch in the cycle-based analysis. Combinations of components in the embodiments are also included in the embodiments of an apparatus, a method, and a program of calculating power consumption.

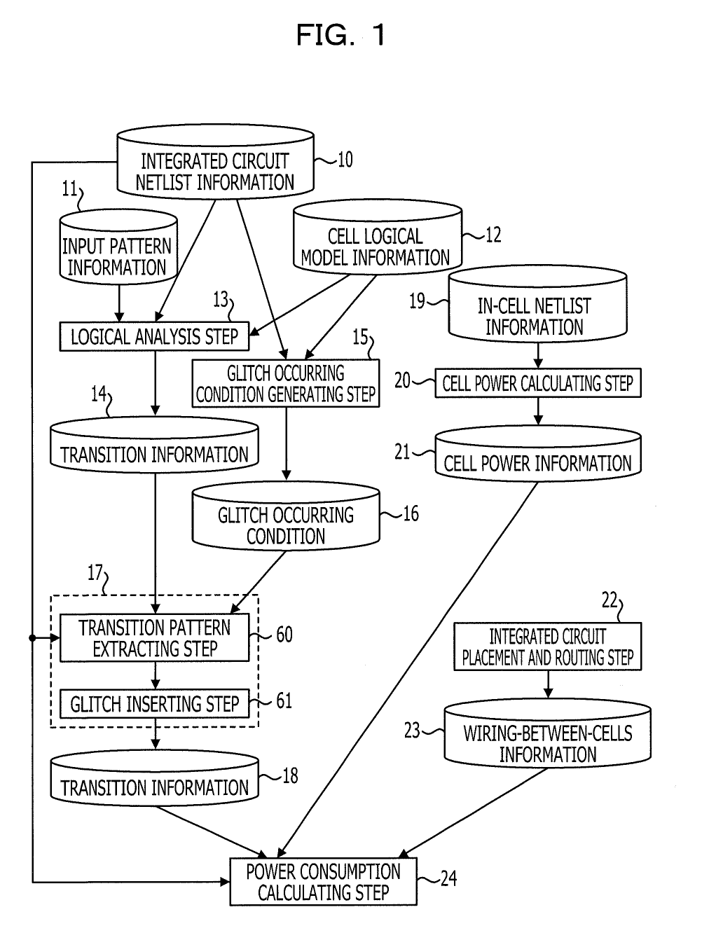

FIG. 1 illustrates an example of the entire flow of calculating power consumption according to an embodiment. In the flow of calculating power consumption in FIG. 1, the power consumption of an integrated circuit is calculated on the basis of input pattern information 11, integrated circuit netlist information 10, cell logical model information 12, and in-cell netlist information 19. The flow of calculating power consumption is performed by a power consumption calculating apparatus 70 described below. The netlist information is connection-between-circuits information representing connection information, for example, between internal circuits or between cells.

The integrated circuit netlist information 10 includes cell information representing the configuration of cells and connection information representing the connection between the cells. The cells are circuit macros serving as circuit blocks composing the integrated circuit. The input pattern information 11 represents the pattern of an input signal into the integrated circuit. The cell logical model information 12 represents connection relationship between input and output logics of each cell described in the integrated circuit netlist information 10. The in-cell netlist information 19 defines a model in a transistor level of each cell.

In a logical analysis step 13, the power consumption calculating apparatus 70 performs logical analysis of the integrated circuit in the cycle-based manner. Specifically, in the logical analysis step 13, the power consumption calculating apparatus 70 performs logical simulation on the basis of the integrated circuit netlist information 10, the input pattern information 11, and the cell logical model information 12 on the assumption that no propagation delay occurs between the cells in the integrated circuit to detect transition information 14 of input and output signals of each cell composing the integrated circuit. The transition information indicates when and how the logical values of the input signal and the output signal into and from the circuit make transition.

In a glitch occurring condition generating step 15, the power consumption calculating apparatus 70 generates a glitch occurring condition on the basis of the logical relationship between the input and output signals in the cell logical model information 12. The glitch occurring condition is a transition pattern of the input signal into the cell, which causes a glitch in the output from the cell. Specifically, in the glitch occurring condition generating step 15, the power consumption calculating apparatus 70 generates a glitch occurring condition 16 by using the cell logical model information 12 as an input and outputs the generated glitch occurring condition 16. The glitch occurring condition 16 may be generated in advance before the calculation of the power consumption. The glitch occurring condition generating step 15 will be described in detail below.

A transition information converting step 17 includes a transition pattern extracting step 60 of extracting the presence of the generated glitch occurring condition 16 in the transition information 14 about the input signal into the cell composing the integrated circuit. In addition, the transition information converting step 17 includes a glitch inserting step 61 of generating a glitch in the output signal from the cell corresponding to the detected transition information 14. In the present embodiment, the glitch is a step signal whose logical value is varied for every half cycle. In the transition information converting step 17, the power consumption calculating apparatus 70 outputs transition information 18 in which the glitch is inserted into the output from the cell.

In a cell power calculating step 20, the power consumption calculating apparatus 70 performs circuit analysis in the transistor level by using a circuit analysis and simulation method, such as Simulation Program with Integrated Circuit Emphasis (SPICE). Specifically, in the cell power calculating step 20, the power consumption calculating apparatus 70 performs the processing by using the in-cell netlist information 19 as an input. In the cell power calculating step 20, the power consumption calculating apparatus 70 outputs cell power information 21 when the cell operates.

In an integrated circuit placement and routing step 22, the power consumption calculating apparatus 70 converts wiring conditions including the length and the width of the wiring between cells into an equivalent circuit. Specifically, in the integrated circuit placement and routing step 22, the power consumption calculating apparatus 70 replaces the wiring between the cells with a capacitance value on the basis of the wiring conditions of the wiring between the cells. In the integrated circuit placement and routing step 22, the power consumption calculating apparatus 70 outputs the wiring information replaced with the capacitance value as wiring-between-cells information 23.

In a power consumption calculating step 24, the power consumption calculating apparatus 70 calculates the power consumption of the integrated circuit. Specifically, in the power consumption calculating step 24, the power consumption calculating apparatus 70 calculates the power consumption of the integrated circuit from the transition information 18 in which the occurrence of the glitch is reflected, the cell power information 21, and the wiring-between-cells information 23.

As described above, in the cycle-based analysis, the power consumption calculating apparatus 70 generates the glitch occurring condition from the logical model of the cell and reflects the occurrence of the glitch in the transition information to efficiently calculate the power consumption of the integrated circuit in consideration of the occurrence of the glitch.

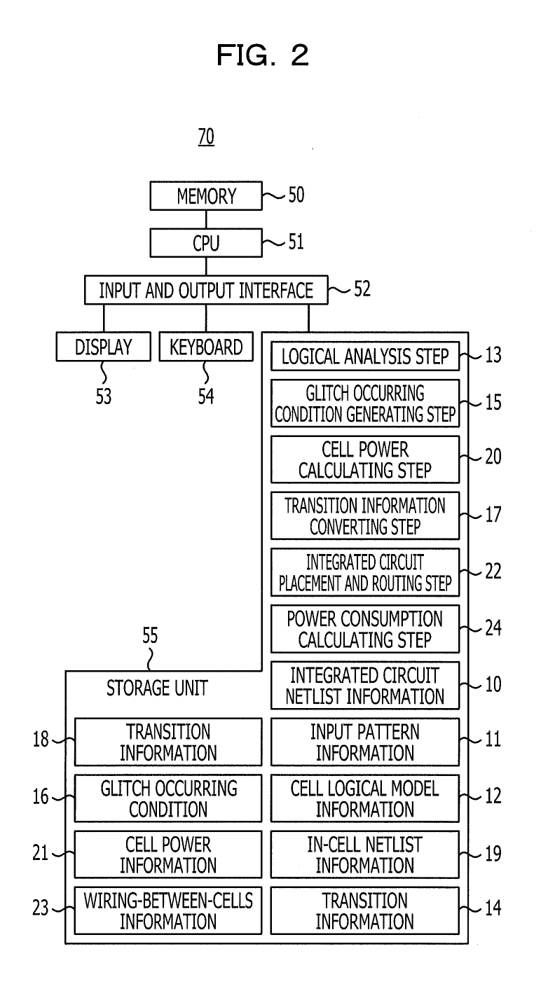

FIG. 2 is an exemplary block diagram of the power consumption calculating apparatus 70 calculating the power consumption of an integrated circuit. Referring to FIG. 2, the power consumption calculating apparatus 70 includes a memory 50, a central processing unit (CPU) 51, an input and output interface 52, a display 53, a keyboard 54, and a storage unit 55. The storage unit 55 is, for example, a hard disk drive (HDD).

The CPU 51 is a control unit that executes the processing for calculating the power consumption of the integrated circuit. The memory 50 stores, for example, programs executed by the CPU 51 or the result of the calculation of the power consumption of the integrated circuit calculated in the CPU 51.

The display 53 displays, for example, a screen on which parameters for calculating the power consumption of the integrated circuit are input and a screen on which the result of the calculation of the power consumption of the integrated circuit is indicated. The keyboard 54 is used by a user, for example, to input the parameters for calculating the power consumption of the integrated circuit.

The storage unit 55 stores programs causing the CPU 51 to perform the logical analysis step 13, the glitch occurring condition generating step 15, the cell power calculating step 20, the transition information converting step 17, the integrated circuit placement and routing step 22, and the power consumption calculating step 24 according to the present embodiment, which are used to calculate the power consumption of the integrated circuit. In addition, the storage unit 55 stores the integrated circuit netlist information 10, the input pattern information 11, the cell logical model information 12, the in-cell netlist information 19, the transition information 14, the transition information 18, the glitch occurring condition 16, the cell power information 21, and the wiring- between-cells information 23, which are input and output data for each program. The integrated circuit netlist information 10, the input pattern information 11, the cell logical model information 12, the in-cell netlist information 19, the transition information 14, the transition information 18, the glitch occurring condition 16, the cell power information 21, and the wiring-between-cells information 23 may be files in which the corresponding information is described.

The logical analysis step 13, the glitch occurring condition generating step 15, the cell power calculating step 20, the transition information converting step 17, the integrated circuit placement and routing step 22, and the power consumption calculating step 24 according to the present embodiment, which realize the calculation of the power consumption of the integrated circuit, may be executed by a computer as programs or may be stored in a computer-readable storage medium. The computer-readable storage medium is, for example, a magnetic recording device, an optical disk, or a semiconductor memory.

In distribution of the programs, for example, a portable storage medium, such as a digital versatile disk (DVD) or a compact disk-read only memory (CD-ROM), on which the programs are recorded is used. Alternatively, the programs may be stored in a storage unit in a server computer and may be transferred from the server computer to another computer over a network.

The input and output interface 52 controls transmission and reception of data between the CPU 51 and the display 53, the keyboard 54, and the storage unit 55. The display 53 receives the result of the calculation of the power consumption of the integrated circuit calculated in the CPU 51 through the input and output interface 52 to display the result on the screen. The keyboard 54 transmits calculation conditions for calculating the power consumption of the integrated circuit, input by the user, to the CPU 51 through the input and output interface 52. The memory 50 receives the programs used in the calculation of the power consumption of the integrated circuit, stored in the storage unit 55, through the input and output interface 52 and stores the received programs. The CPU 51 reads out the programs stored in the memory 50 to calculate the power consumption of the integrated circuit. The memory 50 stores the result of the calculation of the power consumption of the integrated circuit, calculated by the CPU 51. The memory 50 supplies the stored result of the calculation of the power consumption of the integrated circuit to the storage unit 55 through the input and output interface 52.

As described above, the calculation of the power consumption of the integrated circuit according to the present embodiment is performed by using the power consumption calculating apparatus 70.

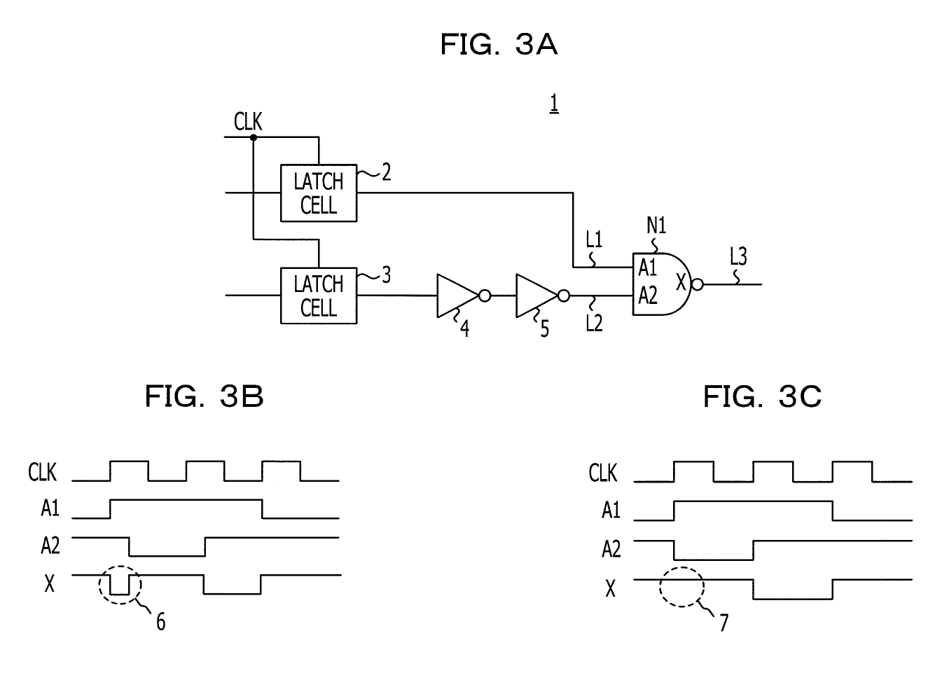

FIGS. 3A to 3C include a circuit diagram of a circuit for which the power consumption is to be calculated and diagrams indicating operating waveforms. FIG. 3A is an exemplary circuit diagram of the circuit for which the power consumption is to be calculated. FIG. 3B illustrates an exemplary result of the event-driven analysis. FIG. 3C illustrates an exemplary result of the cycle-based analysis.

Referring to FIG. 3A, an integrated circuit 1 includes latch cells 2 and 3, NOT (negative) cells (inverter cells) 4 and 5, and a NAND cell N1. The latch cells 2 and 3 each hold a signal input in synchronization with the timing of a clock signal CLK and output the signal. An input terminal A1 of the NAND (NOT AND) cell N1 receives a signal that is output from the latch cell 2 and is propagated on a line L1. An input terminal A2 of the NAND cell N1 receives a signal that is output from the latch cell 3, is through the NOT cells 4 and 5, and is propagated on a line L2. The NAND cell N1 outputs an output signal from an output terminal X in accordance with the logics of the input signals received with the input terminals A1 and A2. The output signal from the NAND cell N1 is propagated on a line L3.

FIG. 3B illustrates exemplary waveforms as the result of the event-driven analysis of the integrated circuit 1 in FIG. 3A. Referring to FIG. 3B, CLK represents the waveform of the clock signal CLK input into the latch cells 2 and 3. A1 illustrates the waveform input into the input terminal A1 of the NAND cell N1. A2 illustrates the waveform input into the input terminal A2 of the NAND cell N1. X illustrates the waveform output from the output terminal X of the NAND cell N1.

In the waveforms in FIG. 3B, a glitch occurs in the waveform X, as illustrated in a waveform 6. This is because the time during which the signal output from the latch cell 2 at the timing of the clock signal CLK is input into the input terminal A1 is different from the time during which the signal output from the latch cell 3 at the timing of the clock signal CLK is input into the input terminal A2 due to the effect of the delay caused by the NOT cells 4 and 5. Since the propagation delay caused by the elements is considered in the event-driven analysis, as illustrated in FIG. 3B, it is possible to perform the analysis in consideration of the occurrence of the glitch.

FIG. 3C illustrates exemplary waveforms as the result of the cycle-based analysis of the integrated circuit 1 in FIG. 3A. Referring to FIG. 3C, CLK represents the waveform of the clock signal CLK input into the latch cells 2 and 3. A1 illustrates the waveform input into the input terminal A1 of the NAND cell N1. A2 illustrates the waveform input into the input terminal A2 of the NAND cell N1. X illustrates the waveform output from the output terminal X of the NAND cell N1.

The glitch occurring in the waveform 6 in FIG. 3B does not occur in FIG. 3C, as illustrated in a waveform 7. The glitch does not occur because the effect of the delay caused by the NOT cells 4 and 5 is not considered in the cycle-based analysis.

The relationship between the circuit diagram in FIG. 3A and the power consumption calculating flow in FIG. 1 will now be described. The cell logical model information 12 defines the logical model of each of the latch cells 2 and 3, the NOT cells 4 and 5, and the NAND cell N1. The in-cell netlist information 19 defines the detailed model of each of the latch cells 2 and 3, the NOT cells 4 and 5, and the NAND cell N1 in the transistor level. The input pattern information 11 defines the pattern of the clock signal CLK input into the latch cells 2 and 3.

The integrated circuit netlist information 10 defines the connection relationship between the latch cells 2 and 3, the NOT cells 4 and 5, and the NAND cell N1. The wiring-between-cells information 23 defines the capacitance value of the wiring between the cells, calculated from the wiring conditions of the lines L1, L2, and L3.

It is possible to efficiently calculate the power consumption of the integrated circuit in consideration of the occurrence of the glitch by performing the cycle-based analysis illustrated in FIG. 1 for the circuit in FIG. 3A on the basis of the above information.

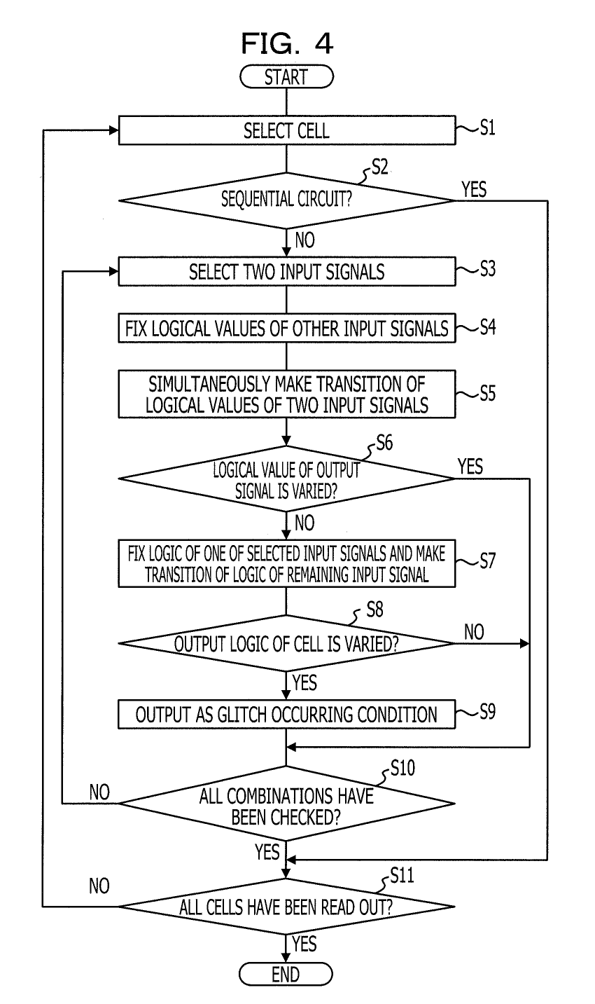

FIG. 4 is a flow chart illustrating an exemplary process of generating the glitch occurring condition 16 from the cell logical model information 12 in the glitch occurring condition generating step 15.

Referring to FIG. 4, in S1 in the glitch occurring condition generating step 15, the CPU 51 refers to the cell logical model information 12 to read out the logical model of a cell described in the integrated circuit netlist information 10 from the cell logical model information 12, that is, the CPU 51 selects a cell of which the glitch occurring condition is to be determined. In S2 in the glitch occurring condition generating step 15, the CPU 51 determines whether the read out cell is a sequential circuit, such as a latch cell. If the read out cell is the sequential circuit (YES in S2), no glitch occurs because the timing when the output signal makes transition is synchronized with the clock signal. Accordingly, the process goes to S11. If the read out cell is not the sequential circuit (NO in S2), in S3 in the glitch occurring condition generating step 15, the CPU 51 selects two input signals from the multiple input signals input into the read out cell.

Although the glitch occurring condition is generated for the cells registered in the netlist in the present embodiment, the glitch occurring condition may be generated before the analysis for the cells registered in the cell logical model information 12 independently of the netlist.

In S4 in the glitch occurring condition generating step 15, the CPU 51 fixes the logical values of the other input signals that are not selected, among the multiple input signals input into the read out cell. The logical values to be fixed here are values that do not inhibit the signal output corresponding to the logical values of the selected two input signals.

In S5 in the glitch occurring condition generating step 15, the CPU 51 simultaneously makes transition of the logical values of the selected two input signals. In S6 in the glitch occurring condition generating step 15, the CPU 51 checks the logical value of the output signal from the cell to determine whether the logical value of the output signal is varied. In other words, the CPU 51 extracts a case in which the logical value of the output signal is not varied even if the logical values of the input signals are simultaneously varied. If the logical value of the output signal is varied (YES in S6), the CPU 51 determines that no glitch occurs and the process goes to S10. If the logical value of the output signal is not varied (NO in S6), in S7 in the glitch occurring condition generating step 15, the CPU 51 fixes the logic of one of the selected input signals and makes transition of the logic of the other input signal. In S8 in the glitch occurring condition generating step 15, the CPU 51 determines whether the output logic of the cell is varied as the result of the transition of the logic of the other input signal. If the output logic of the cell is varied as the result of the transition of the logic of the other input signal (YES in S8), in S9 in the glitch occurring condition generating step 15, the CPU 51 outputs the current input condition of the input signals into the cell as the glitch occurring condition 16. If the output logic of the cell is not varied as the result of the transition of the logic of the other input signal (NO in S8), the CPU 51 determines that no glitch occurs and the process goes to S10. In S10 in the glitch occurring condition generating step 15, the CPU 51 determines whether all the combinations have been checked.

If all the combinations of two input signals, among the multiple input signals into the cell, have been checked (YES in S10), in S11 in the glitch occurring condition generating step 15, the CPU 51 determines whether all the cells referred to in the integrated circuit netlist information 10 have been read out. If all the combinations of two input signals have not been checked (NO in S10), the process goes back to S3 to select another combination of two input signals and generates the glitch occurring condition in the above manner.

If all the cells referred to in the integrated circuit netlist information 10 have been read out (YES in S11), the glitch occurring condition generating step is terminated. If all the cells referred to in the integrated circuit netlist information 10 have not been read out (NO in S11), the process goes back to S1 to read out the subsequent cell and continues the glitch occurring condition generating step.

As described above, it is possible for the CPU 51 to perform the glitch occurring condition generating step 15 to generate the glitch occurring condition from the cell logical model information 12 referred to in the integrated circuit netlist information 10.

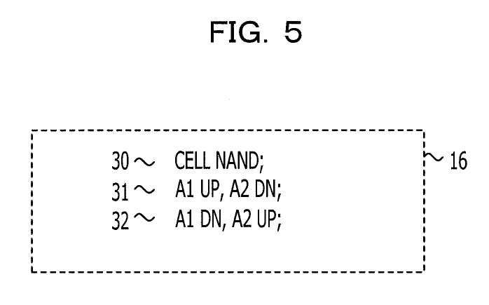

FIG. 5 is an exemplary diagram that defines the glitch occurring condition 16 of the NAND cell generated in the glitch occurring condition generating step 15. Referring to FIG. 5, a row 30 indicates a cell type for which the glitch occurring condition 16 is to be generated. The example in FIG. 5 indicates that the glitch occurring condition 16 concerns the NAND cell. Rows 31 and 32 indicate how the logical values of the two input signals into the cell are varied when the glitch occurs in the output from the cell. The row 31 indicates that a glitch occurs when the logical value of the input into the input terminal A1 is varied from ‘0’ to ‘1’ and the logical value of the input into the input terminal A2 is varied from ‘1’ to ‘0.’ The row 32 indicates that a glitch occurs when the logical value of the input into the input terminal A1 is varied from ‘1’ to ‘0’ and the logical value of the input into the input terminal A2 is varied from ‘0’ to ‘1.’ In the rows 31 and 32, UP indicates that the logical value is varied from ‘0’ to ‘1’ and DN indicates that the logical value is varied from ‘1’ to ‘0.’

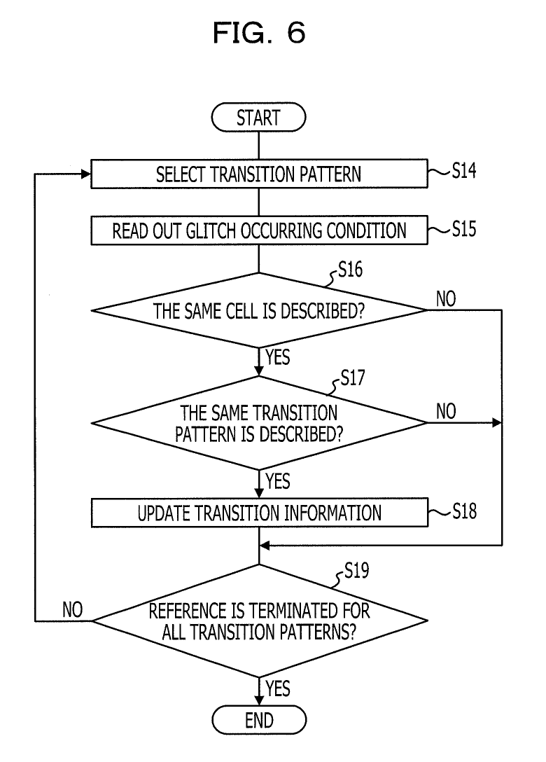

FIG. 6 is a flow chart illustrating an exemplary process of converting the transition information 14 into the transition information 18 into which the glitch is inserted. The glitch insertion is performed in the transition information converting step 17. The transition information conversion is performed by receiving state transition information about the signal terminals of each cell from the logical simulation and the glitch occurring condition of each cell from the glitch occurring condition generating step to find a portion in the state transition information, which coincides with the glitch occurring condition, and converting the pattern of the state transition information on the portion.

Referring to FIG. 6, in S14 in the transition information converting step 17, the CPU 51 refers to the transition information 14 to select part of the transition pattern of the input signals into one cell. Specifically, the CPU 51 reads out the transition pattern of two successive cycles of the input and output signal terminals of one cell from the signal terminal transition information file. Information about terminal names, cell instance names of the terminals, and a cell type is also included in the transition information. In the transition information converting step 17, the CPU 51 converts a part where the logic is varied from ‘0’ to ‘1’ into ‘UP’ and a part where the logic is varied from ‘1’ to ‘0’ into ‘DN’ in the selected transition pattern.

In S15 in the transition information converting step 17, the CPU 51 reads out the glitch occurring condition 16 generated in the glitch occurring condition generating step 15. The CPU 51 searches for the corresponding glitch occurring condition file on the basis of the cell type of the selected cell.

In S16 in the transition information converting step 17, the CPU 51 determines whether the cell corresponding to the selected transition pattern is described in the glitch occurring condition 16. If the cell corresponding to the selected transition pattern is not described in the glitch occurring condition 16 (NO in S16), the process goes to S19. If the cell corresponding to the selected transition pattern is described in the glitch occurring condition 16 (YES in S16), in S17 in the transition information converting step 17, the CPU 51 determines whether the transition pattern coinciding with the selected transition pattern is described in the glitch occurring condition 16.

If the transition pattern coinciding with the selected transition pattern is not described in the glitch occurring condition 16 (NO in S17), the process goes to S19. In S19 in the transition information converting step 17, the CPU 51 determines whether the reference to the glitch occurring condition 16 is terminated for all the transition patterns described in the transition information 14. If the transition pattern coinciding with the selected cell is described in the glitch occurring condition 16 (YES in S17), in S18 in the transition information converting step 17, the CPU 51 inverts the logical value of the output pattern in the transition information 14 so that a glitch occurs in the output signal corresponding to the selected transition pattern. The CPU 51 outputs the signal terminal transition information in which the output pattern is inverted to a file.

If the reference to the glitch occurring condition 16 is not terminated for all the transition patterns described in the transition information 14 (NO in S19), the process goes back to S14 to perform the transition information updating process to the remaining transition patterns for which the reference to the glitch occurring condition 16 is not terminated. If the reference to the glitch occurring condition 16 is terminated for all the transition patterns described in the transition information 14 (YES in S19), the transition information updating process is terminated. The CPU 51 performs the transition information updating process for all the transition patterns.

As described above, in the transition information converting step 17, the CPU 51 compares the transition pattern of the input signals into the cell described in the transition information 14 with the pattern of the corresponding cell described in the glitch occurring condition 16 to identify the transition pattern where a glitch occurs and converts the identified transition pattern to cause a glitch in the output from the cell. Since the detection of the glitch occurring condition is performed without considering the timing of the input signals in this method, an occurrence of a glitch that actually not occur can be evaluated. However, it is possible to pessimistically estimate the power in the calculation of the power consumption during the design of the LSI to determine the upper limit of the power consumption in the actual operation during the design.

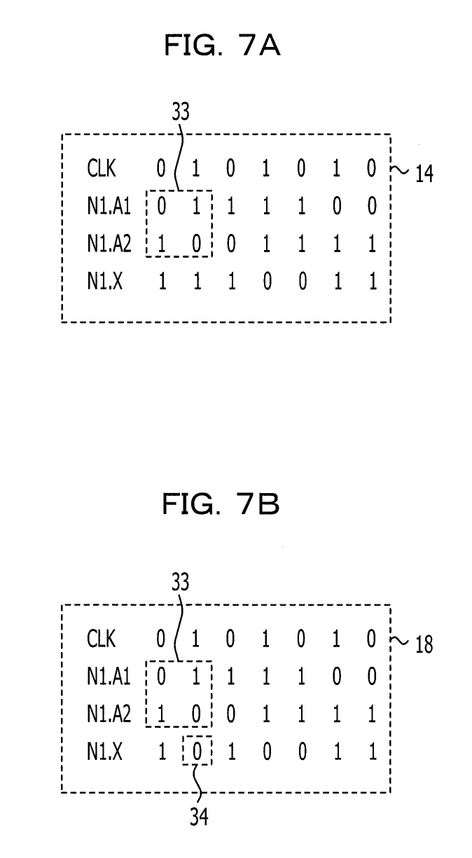

FIGS. 7A and 7B illustrates exemplary transition patterns before the conversion of the transition information and after the conversion of the transition information. FIG. 7A illustrates an example of the transition information 14 before the transition information is converted in the transition information converting step 17. FIG. 7B illustrates an example of the transition information 18 after the transition information is converted in the transition information converting step 17.

Referring to FIG. 7A, a transition pattern 33 is part of the transition pattern of the NAND cell N1. CLK indicates the transition pattern of the clock signal CLK in the integrated circuit 1. N1.A1 indicates the transition pattern of the input signal into the input terminal A1 of the NAND cell N1. N1.A2 indicates the transition pattern of the input signal into the input terminal A2 of the NAND cell N1. N1.X indicates the transition pattern of the output signal from the output terminal X of the NAND cell N1.

The transition pattern 33 is part of the transition pattern selected by the CPU 51 in the transition information converting step 17. In the present embodiment, the transition pattern 33 is the transition pattern corresponding to one cycle of the clock signal CLK. Since N1.A1 is varied from ‘0’ to ‘1’ and N1.A2 is varied from ‘1’ to ‘0’, the transition pattern 33 is represented as ‘A1 UP, A2 DN.’ The CPU 51 searches for the glitch occurring condition 16 on the basis of the cell type of the selected cell. The pattern coinciding with the transition pattern 33 that is selected is described in the row 31 of the NAND cell in the glitch occurring condition 16 in FIG. 5. Accordingly, it is determined in the transition information converting step 17 that a glitch occurs in the transition pattern 33.

In the transition information converting step 17, the CPU 51 inverts the logical value of the output signal at the timing when the transition pattern of the input signal meeting the glitch occurring condition is confirmed to insert a glitch in the output signal from the NAND cell. In the example in FIG. 7B, the CPU 51 varies the logical value of a transition pattern 34 of the output signal N1.X from ‘1’ to ‘0’ to insert a glitch pattern whose logical value is varied from ‘1’ to ‘0’ and, then, is varied from ‘0’ to ‘1’ into the transition information about the output signal N1.X.

In the transition information converting step 17, the CPU 51 compares the transition pattern of the input signals into the cell described in the transition information 14 with the pattern of the corresponding cell described in the glitch occurring condition 16 to identify the transition pattern where a glitch occurs and reflects the occurrence of the glitch in the identified transition information in the above manner. The calculation of the power consumption of the integrated circuit after the glitch pattern is inserted will now be described.

The CPU 51 calculates the power consumption of each cell type in the signal state in which the corresponding glitch is considered from the power of the cell on the basis of the transition information subjected to the conversion for the insertion of the glitch. The CPU 51 calculates the capacitance of the wiring between cells from the wiring-between-cells information acquired from the LSI placement and routing. The CPU 51 performs the above processing for all the cells and sums up the respective power consumptions to calculate the power consumption of the LSI in the first operating cycle. The CPU 51 repeats the above calculation for all the operating cycles acquired in the LSI simulation to calculate the power consumption of the LSI in all the operating cycles in consideration of the glitch.

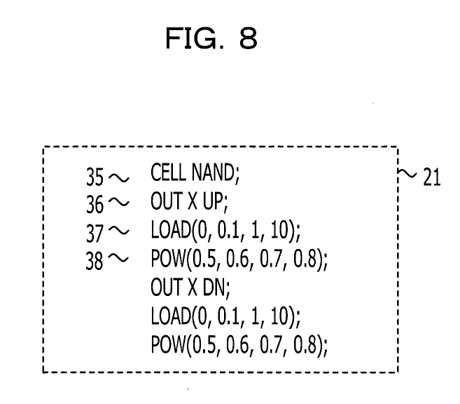

FIG. 8 is an exemplary diagram that defines the cell power information 21. Referring to FIG. 8, a row 35 indicates a cell type for which the power consumption is to be calculated. The row 35 in FIG. 8 indicates that the definition in the cell power information 21 concerns the NAND cell. A row 36 indicates that the power consumption is defined when the output signal from the output terminal X of the NAND cell is varied from ‘0’ to ‘1.’ The definition is provided because the power consumption of the cell in UP may be different from that in DN. A row 37 indicates the values of load capacitances due to, for example, the wiring. In the example in FIG. 8, four load capacitances are indicated. A row 38 indicates the power consumption corresponding to each load capacitance value defined in the row 37. The wiring conditions can be equivalently converted into capacitance values on the assumption that the output load of the cell is the wiring. The power consumption of the cell is varied with the load capacitance value. In general, the power consumption of the cell is increased with the increasing load capacitance value. The rows 37 and 38 indicate that the power consumption is equal to 0.5 μW when the load capacitance value is equal to 0 fF, the power consumption is equal to 0.6 μW when the load capacitance value is equal to 0.1 fF, the power consumption is equal to 0.7 μN when the load capacitance value is equal to 1 fF, and the power consumption is equal to 0.8 μW when the load capacitance value is equal to 10 fF.

As apparent from the cell power information 21, in the example in FIG. 8, the power consumption in the cell occurs when the output signal from the cell makes transition. Accordingly, it is possible for the CPU 51 to perform the power calculation in consideration of an increase in the power consumption in the integrated circuit due to the occurrence of the glitch by inserting the glitch pattern into the transition information, as illustrated in FIGS. 7A and 7B, to increase the number of times of the transition of the output signal.

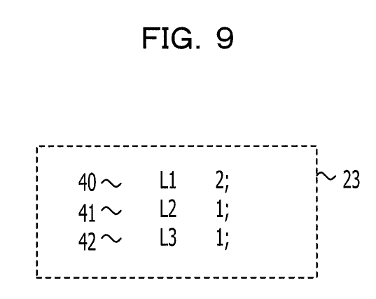

FIG. 9 is an exemplary diagram that defines the wiring-between-cells information 23. The wiring-between-cells information 23 defines the capacitance value resulting from the equivalent conversion of the wiring between cells. Referring to FIG. 9, a row 40 indicates that the capacitance value of the line L1 is equal to 2 fF. A row 41 indicates that the capacitance value of the line L2 is equal to 1 fF. A row 42 indicates that the capacitance value of the line L3 is equal to 1 fF.

In the power consumption calculating step 24, the CPU 51 refers to the transition information 18, the cell power information 21, and the wiring-between-cells information 23 to calculate the power consumption of the integrated circuit in the cycle-based manner. In the power consumption calculating step 24, the CPU 51 reads out the transition pattern of N1.X, which is the output signal from the NAND cell N1, from the transition information 18. Since the line L3 is connected to N1.X, which is the output signal from the NAND cell N1, as illustrated in FIG. 3A, it is determined from the wiring-between-cells information 23 that the load capacitance value of the NAND cell N1 is equal to 1 fF. The CPU 51 refers to the cell power information 21 to determine the power consumption of the NAND cell N1 when the load capacitance value is equal to 1 fF. Accordingly, it is possible for the CPU 51 to calculate the power consumption of the integrated circuit in consideration of the occurrence of the glitch by inserting the glitch pattern, as in the transition information 18.

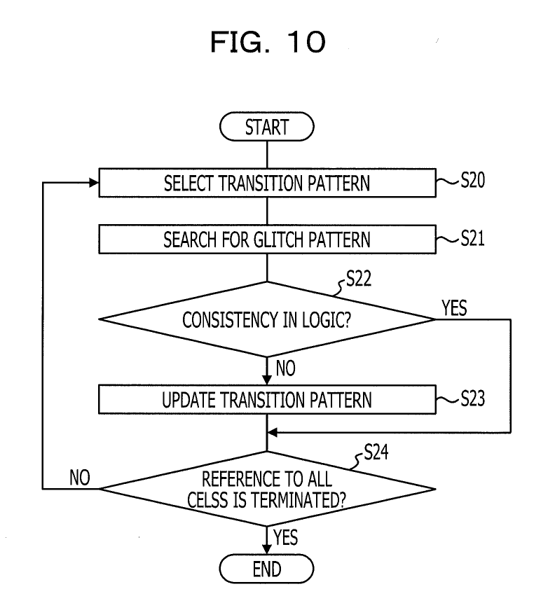

FIG. 10 is a flow chart illustrating an exemplary process of converting the transition information 18 after the insertion of the glitch. The insertion of the glitch in the output transition pattern in the transition information 18 may cause inconsistency between the logics of the input signal into the cell and the output signal from the cell and the content defined in the cell logical model information 12. This is because the input delay is not considered in the cycle-based power analysis and the glitch is inserted into the output regardless of the simultaneous transition of the input signal to cause the inconsistency between the input logic and the output logic. The inconsistency between the input logic and the output logic of the cell can cause an error in the calculation of the power consumption of the integrated circuit to stop the calculation.

Referring to FIG. 10, in S20 in the transition information converting step 17, the CPU 51 selects a transition pattern in one cell from the transition information 18. In S21, the CPU 51 searches the selected transition pattern for the glitch pattern whose logical value is varied on the half cycle of the clock signal CLK. Since the glitch pattern makes transition on the same cycle as that of the clock signal CLK, the CPU 51 can search the transition pattern to identify the timing when the glitch pattern occurs.

In S22 in the transition information converting step 17, the CPU 51 confirms whether the logic of the output signal from the cell and the logic of the input signal into the cell are consistent with the cell logical model information 12 at the timing when the identified glitch pattern occurs. Specifically, the CPU 51 determines the logical value of the input signal into the cell at the timing when the glitch pattern occurs and the logical value of the output signal estimated from the cell logical model information 12 and compares the determined logical values with the logical values in the glitch pattern.

If the logical value of the output signal in the glitch pattern is consistent with the logical value determined on the basis of the cell logical model information 12 (YES in S22), no logical inconsistency error occurs. Accordingly, the process goes to S24. If the logical value of the output signal in the glitch pattern is not consistent with the logical value determined on the basis of the cell logical model information 12 (NO in S22), in S23, the CPU 51 updates the transition pattern of the input signal into the cell so that the transition pattern in the transition information 18 is consistent with the cell logical model information 12.

In S24, the CPU 51 determines whether the reference to all the cells described in the transition information 18 is terminated. If the reference to all the cells described in the transition information 18 is not terminated (NO in S24), the process goes back S20 to perform the transition information updating process to another cell that is not referred to. If the reference to all the cells described in the transition information 18 is terminated (YES in S24), the transition information updating process is terminated.

As described above, it is possible to avoid an occurrence of an error caused by the inconsistency between the input logic and the output logic of the cell by performing the transition information updating process to the transition information 18.

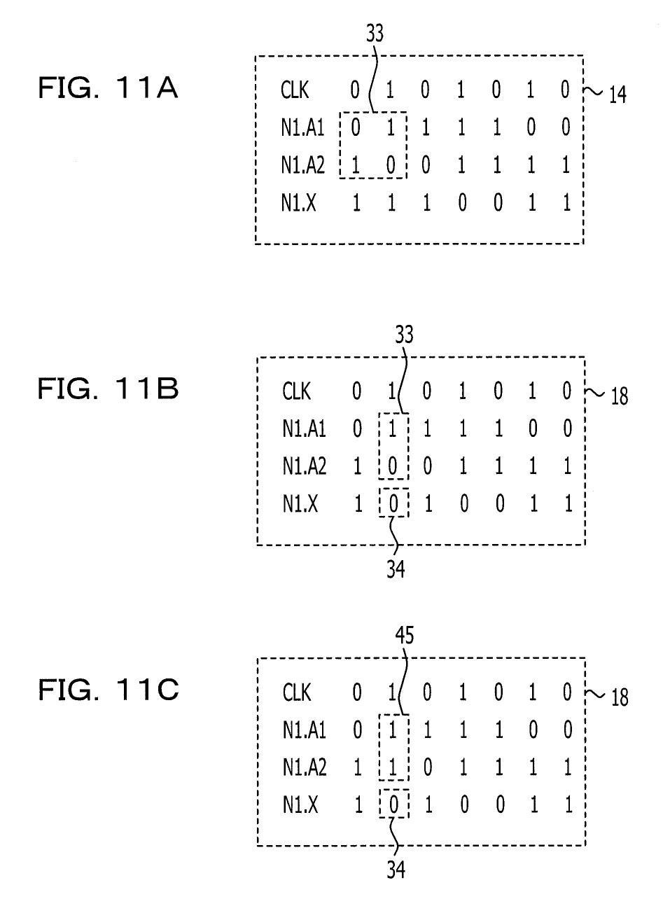

FIGS. 11A to 11C illustrate exemplary transition patterns before and after the transition information conversion. FIG. 11A illustrates an exemplary transition pattern in the transition information 14 before the transition information conversion. FIG. 11B illustrates an example transition pattern in the transition information 18 after a glitch is inserted in the transition information conversion. FIG. 11C illustrates an exemplary transition pattern in the transition information 18 after the transition pattern of the input signal into the cell is updated so that the input and output logics of the cell after the insertion of the glitch are consistent with the cell logical model information 12.

In the example in FIG. 11A, if the CPU 51 selects the transition pattern 33 and determines that the transition pattern 33 meets the glitch occurring condition 16, in the transition information converting step 17, the CPU 51 varies the logical value of the transition pattern 34 in FIG. 11B from ‘1’ to ‘0.’

When one logical value is equal to ‘1’ and the other logical value is equal to ‘0’ in the input and output logics of the NAND cell, the output logical value of the NAND cell becomes equal to ‘1.’ When the glitch pattern is inserted into the output from the NAND cell, as in the transition pattern 34 in FIG. 11B, the output logical value becomes equal to ‘0’ when the logical values ‘1’ and ‘0’ are input into the NAND cell, as in an input transition pattern 45, and the input logic is inconsistent with the output logic.

In the transition information converting step 17, if the CPU 51 finds such inconsistency between the input logic and the output logic at the timing when the glitch is inserted, the CPU 51 inverts one logic in the input transition pattern 45, as illustrated in FIG. 11C, to update the transition information 18 so that the input logic is consistent with the output logic.

As described above, the input transition pattern can be updated so that the input logic is consistent with the output logic at the timing when the glitch pattern is inserted to avoid an occurrence of an error caused by the inconsistency between the input logic and the output logic of the cell.

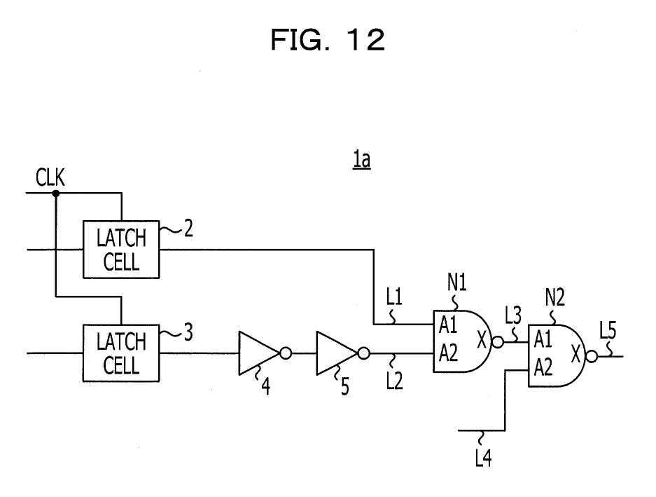

FIG. 12 is an exemplary circuit diagram of the circuit for which the power consumption is to be calculated. An integrated circuit is in FIG. 12 results from connection of one input terminal A1 of a NAND cell N2, which is a reception circuit, to the output of the NAND cell N1 via the line L3 in the integrated circuit 1 in FIG. 3A. The other input terminal A2 of the NAND cell N2 is connected to a line L4. The output of the NAND cell N2 is connected to a line L5. In the remaining configuration, the same reference numerals are used in FIG. 12 to identify the same components illustrated in FIG. 3A. A description of such components is omitted herein. In an actual phenomenon, a glitch occurring in the previous-stage cell may pass through the subsequent-stage cell. The method of calculating the power consumption in consideration of propagation of the glitch to the subsequent-stage cell will now be described, taking a case in which a glitch pattern inserted into the output signal of the NAND cell N1 is propagated to the output of the NAND cell N2, which is the reception circuit, as an example.

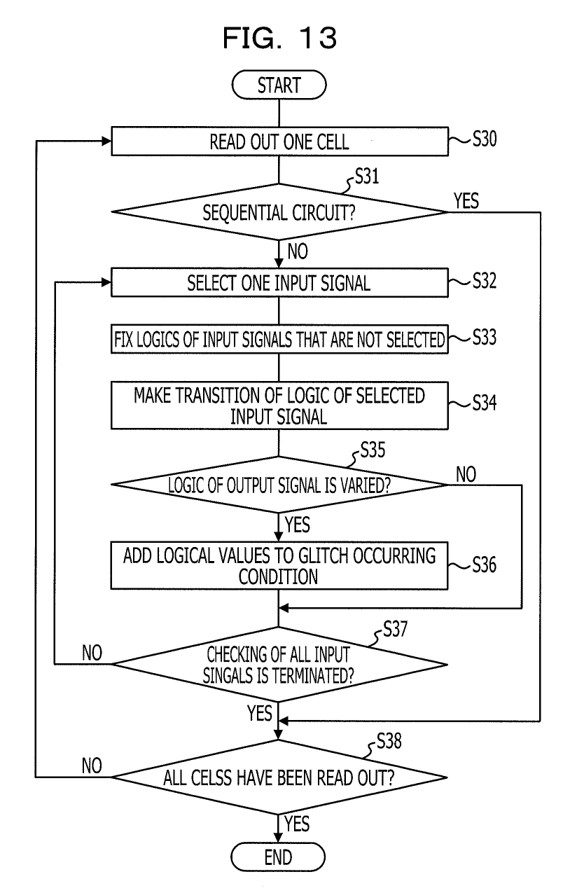

FIG. 13 is a flow chart illustrating an exemplary process of generating a glitch propagation condition. Upon occurrence of a glitch in the input signal of each cell type, the CPU 51 supplies a condition in which the glitch is propagated to the output signal as the glitch propagation condition to a file. The process of generating the glitch propagation condition is described with reference to FIG. 13. In the present embodiment, the glitch propagation condition is generated by the CPU 51 that executes the glitch occurring condition generating step 15. The generated glitch propagation condition is added to the glitch occurring condition 16. The glitch propagation condition may be supplied to a file different from that of the glitch occurring condition 16.

Referring to FIG. 13, in S30 in the glitch occurring condition generating step 15, the CPU 51 reads out one cell described in the integrated circuit netlist information 10 from the cell logical model information 12. In S31, the CPU 51 determines whether the read out cell is a sequential circuit, such as a latch cell. If the read out cell is a sequential circuit (YES in S31), the CPU 51 determines that the glitch is not propagated and the process goes to S38. If the read out cell is not a sequential circuit but a combination circuit (NO in S31), in S32, the CPU 51 selects one input signal from the input signals into the cell.

In S33 in the glitch occurring condition generating step 15, the CPU 51 fixes the logics of the input signals into the cell, which are not selected. In S34, the CPU 51 makes transition of the logic of the selected input signal. In S35, the CPU 51 determines whether the logic of the output signal from the cell is varied as the result of the transition of the logic of the selected input signal. If the logic of the output signal from the cell is varied as the result of the transition of the logic of the selected input signal (YES in S35), in S36, the CPU 51 adds the logical values of the input signals that are not selected to the glitch occurring condition 16 as the glitch propagation condition. If the logic of the output signal from the cell is not varied as the result of the transition of the logic of the selected input signal (NO in S35), the CPU 51 determines that the glitch is not propagated under the condition of the input signal and the process goes to S37. In S37 in the glitch occurring condition generating step 15, the CPU 51 determines whether the checking of all the input signals into the read out cell is terminated.

If the checking of all the input signals into the read out cell is not terminated (NO in S37), the process goes back to S32 to check another input signal that is not checked. If the checking of all the input signals into the read out cell is terminated (YES in S37), in S38 in the glitch occurring condition generating step 15, the CPU 51 determines whether all the cells registered in the cell logical model information 12 have been read out.

If all the cells registered in the cell logical model information 12 have not been read out (NO in S38), the process goes back to S30 to read out another cell that is not read out and performs the process of generating the glitch propagation condition to the read out cell. If all the cells registered in the cell logical model information 12 have been read out (YES in S38), the process of generating the glitch propagation condition is terminated.

As described above, it is possible for the CPU 51 to generate the glitch propagation condition from the cell logical model information 12 in the glitch occurring condition generating step 15.

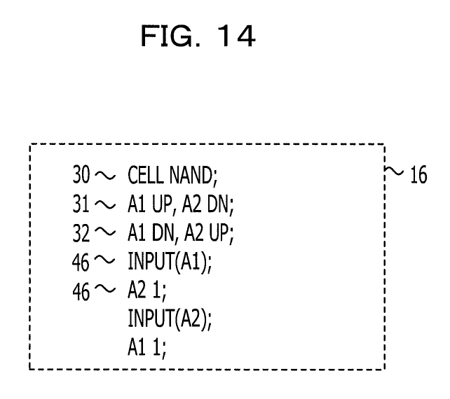

FIG. 14 is an exemplary diagram that defines the glitch occurring condition 16 to which the glitch propagation condition is added. In the glitch occurring condition 16, a row 46 indicates that a pattern causing a glitch is inserted into the input terminal A1 of the NAND cell N1. A row 47 indicates that the pattern causing the glitch inserted into the input terminal A1 is propagated to the NAND cell N2 if the logical value of the signal input into the input terminal A2 is equal to Since the rows 30, 31, and 32 are the same as those in FIG. 5, a description of the rows 30, 31, and 32 is omitted herein. The glitch propagation condition is defined for the other input terminal A2 in the same manner.

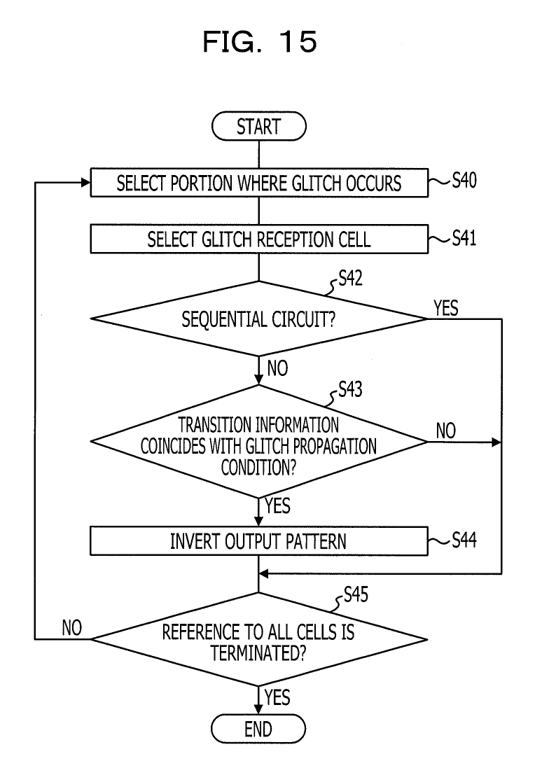

FIG. 15 is a flow chart illustrating an exemplary process of converting the transition information. The CPU 51 performs the process in FIG. 15 in the transition information converting step 17. The CPU 51 can refer to and process the glitch occurring condition 16 to which the glitch propagation condition is added to determine that the glitch pattern inserted into the transition information is propagated to the output from the subsequent-stage cell and to reflect the glitch in the transition information in the output from the subsequent-stage cell.

Referring to FIG. 15, in S40 in the transition information converting step 17, the CPU 51 searches for the output pattern of the cell that makes transition on the same cycle as that of the clock signal CLK and selects the output pattern as a portion where a glitch occurs. In S41, the CPU 51 selects a glitch reception cell, which is a reception circuit receiving the selected output pattern

In S42, the CPU 51 determines whether the selected glitch reception cell is a sequential circuit, such as a latch circuit. If the selected glitch reception cell is a sequential circuit, such as a latch circuit (YES in S42), the CPU 51 determines that the glitch is not propagated to the glitch reception cell and the process goes to S45. If the selected glitch reception cell is not a sequential circuit, such as a latch circuit, but a combination circuit (NO in S42), in S43, the CPU 51 compares the transition information 14 about the input signal into the selected glitch reception cell with the glitch propagation condition of the cell defined in the glitch occurring condition 16. If the comparison indicates that the transition information 14 about the input signal into the selected glitch reception cell does not coincide with the glitch propagation condition of the cell defined in the glitch occurring condition 16 (NO in S43), the CPU 51 determines that the received glitch is not propagated and the process goes to S45. If the comparison indicates that the transition information 14 about the input signal into the selected glitch reception cell coincides with the glitch propagation condition of the cell defined in the glitch occurring condition 16 (YES in S43), in S44 in the transition information converting step 17, the CPU 51 inverts the output pattern of the selected glitch reception cell to reflect the glitch.

In S45 in the transition information converting step 17, the CPU 51 determines whether the reference to all the cells is terminated. If the reference to all the cells is not terminated (NO in S45), the process goes back to S40 to continue the glitch propagation process of another glitch reception cell. If the reference to all the cells is terminated (YES in S45), the glitch propagation process is terminated. The above processing is performed to all the transition patterns. The glitch propagation may be performed across multiple cell stages. When the propagation across multiple cell stages is considered, the glitch propagation process is repeated by using the transition information about the signal terminal to which the glitch propagation information is added and which is newly received.

As described above, it is possible to calculate the power consumption of the integrated circuit in consideration of the propagation of the glitch by referring to the glitch occurring condition 16 in which the glitch propagation condition is reflected to insert the glitch pattern in the transition information 14. In addition, the setting of the number of cell stages in which the glitch can be propagated as the glitch propagation condition allows the propagation range of the glitch to be limited to inhibit the power consumption calculated in the calculation of the power consumption of the integrated circuit from being excessively increased.

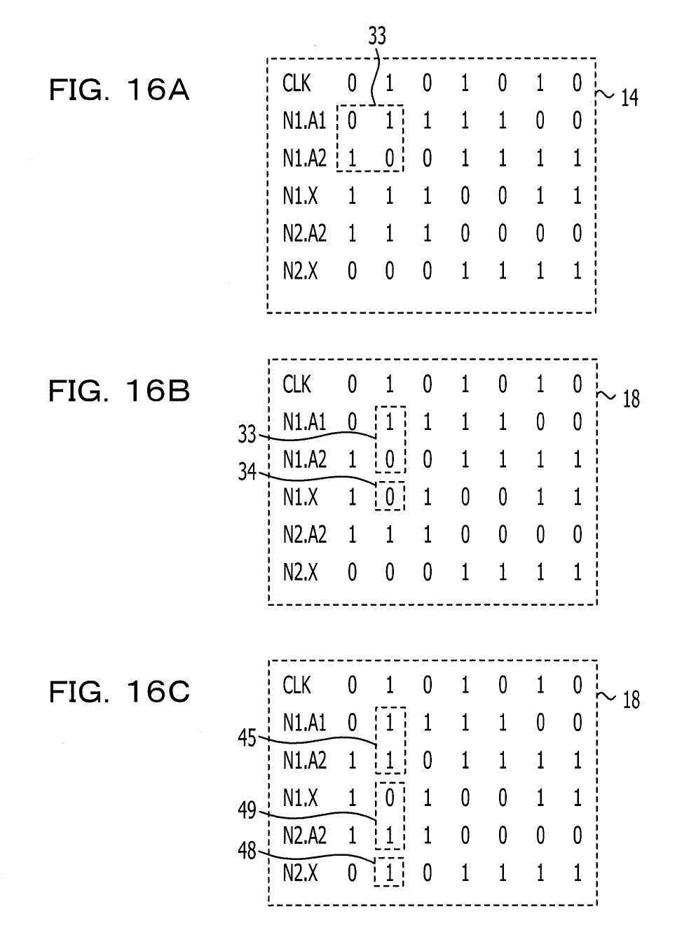

FIGS. 16A to 16C illustrate exemplary transition patterns before and after the conversion of the transition information. FIG. 16A illustrates an exemplary transition pattern in the transition information 14 before the glitch is inserted. FIG. 16B illustrates an exemplary transition pattern in the transition information 18 after the glitch is inserted. FIG. 16C illustrates an exemplary transition pattern in the transition information 18 after the glitch is propagated.

Referring to FIG. 16A, since the clock signal CLK, the input N1.A1 into the NAND cell N1, the input N1.A2 into the NAND cell N1, and the output N1.X from the NAND cell N1 are the same as those in FIGS. 7A and 7B, a description of them is omitted herein. N2.A2 indicates a transition pattern of the input signal into the input terminal A2 of the NAND cell N2. N2.X indicates a transition pattern of the output signal from the output terminal X of the NAND cell N2. Since the output terminal X of the NAND cell N1 is connected to the input terminal A1 of the NAND cell N2 via the line L3 in the integrated circuit 1a in FIG. 12, the transition pattern of the output signal from the output terminal X of the NAND cell N1 is the same as that of the input signal into the input terminal A1 of the NAND cell N2.

Referring to FIG. 16B, the CPU 51 performing the transition information converting step 17 varies the logic of the transition pattern 34 of the output N1.X from ‘1’ to ‘0’ in accordance with the detected transition pattern 33 to insert the glitch. If the CPU 51 detects that the logic of the transition pattern 34 whose logic makes transition and to which the glitch is inserted is not consistent with the logic of the input transition pattern 45, the CPU 51 varies the logic of the transition pattern of the input N1.A2 from ‘0’ to ‘1’ to cause the input logic of the NAND cell N1 to be consistent with the output logic thereof, as illustrated in FIG. 16C.

Referring to FIG. 16C, the CPU 51 performing the transition information converting step 17 compares a transition pattern 49 of the NAND cell N2, which is the glitch reception cell, with the glitch propagation condition in the glitch occurring condition 16 at the timing when the glitch is inserted. The rows 46 and 47 in the glitch occurring condition 16 in FIG. 14 indicate that the glitch is propagated when the glitch is input into the input terminal A1 and the logic of the input terminal A2 is equal to ‘1.’ Accordingly, the CPU 51 determines that the transition pattern 49 meets the glitch propagation condition. The CPU 51 inverts the logic of the output N2.X of the NAND cell N2 from ‘0’ to ‘1’ at the timing when the glitch is propagated, as illustrated in a transition pattern 48.

As described above, it is possible for the CPU 51 to calculate the power consumption of the integrated circuit in consideration of the propagation of the glitch by referring to the glitch occurring condition 16 to which the glitch propagation condition is added to insert the glitch pattern into the transition information 14.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of calculating power consumption of an integrated circuit on the basis of circuit information representing an internal configuration of each circuit included in the integrated circuit and connection-between-circuits information representing connection between the circuits, the method comprising:
acquiring, by a computer, transition information about an input signal and an output signal of the circuit by performing logical analysis, on the assumption that no propagation delay occurs between the circuits, on the basis of input pattern information including an input signal pattern of the integrated circuit, the connection-between-circuits information, and logical model information about the circuit;
extracting, by the computer, from transition patterns of the input signal of the circuit, a transition pattern causing a glitch in the output signal of the circuit on the basis of the logical model information about the circuit;
reflecting, by the computer, the glitch in the transition information about the output signal of the circuit responsive to the input signal having the extracted transition pattern among the acquired transition information; and
calculating, by the computer, the power consumption of the integrated circuit on the basis of the transition information in which the glitch is reflected.

2. The method of claim 1, the method further comprising
when a relationship between a logical value of the input signal of the circuit causing the glitch and a logical value of the corresponding output signal of the circuit is not consistent with logic of the circuit, changing the logical value of the input signal of the circuit in a state in which the logic value of the corresponding output signal of the circuit is fixed so that the relationship is consistent with logic of the circuit.

3. The method of claim 1, the method further comprising:
generating, as a glitch propagation condition, a logical value of an input signal of a reception circuit that receives the output signal including the glitch from the circuit when the reception circuit reflects the received glitch in an output signal of the reception circuit;
determining whether the glitch is propagated to the output signal of the reception circuit on the basis of the generated glitch propagation condition; and
reflecting the glitch in the output signal of the reception circuit when the glitch is propagated from the circuit to the reception circuit.

4. The method of claim 1, the method further comprising:
selecting, among the input signals of the circuit, two input signals that does not cause a logical value of the output signal of the circuit to be varied when logical values of the two input signals are simultaneously varied; and
when the logical value of the output signal of the circuit is varied by varying the logical value of one of the selected two input signals in a state in which the logical value of the other of the selected two input signals is fixed, extracting a transition pattern of the one of the selected two input signals as the transition pattern causing the glitch.

5. A non-transitory computer-readable medium that stores therein a power consumption calculation program causing a computer to execute a process for calculating power consumption of an integrated circuit on the basis of circuit information representing an internal configuration of each circuit included in the integrated circuit and connection-between-circuits information representing connection between the circuits, the process comprising:
acquiring transition information about an input signal and an output signal of the circuit by performing logical analysis, on the assumption that no propagation delay occurs between the circuits, on the basis of input pattern information including an input signal pattern of the integrated circuit, the connection-between-circuits information, and logical model information about the circuit;
extracting, from transition patterns of the input signal of the circuit, a transition pattern causing a glitch in the output signal of the circuit on the basis of the logical model information about the circuit;
reflecting the glitch in the transition information about the output signal of the circuit responsive to the input signal having the extracted transition pattern among the acquired transition information; and
calculating the power consumption of the integrated circuit on the basis of the transition information in which the glitch is reflected.

6. The non-transitory computer-readable medium of claim 5, wherein the process further comprises:
when a relationship between a logical value of the input signal of the circuit causing the glitch and a logical value of the corresponding output signal of the circuit is not consistent with logic of the circuit, changing the logical value of the input signal of the circuit in a state in which the logic value of the corresponding output signal of the circuit is fixed so that the relationship is consistent with logic of the circuit.

7. The non-transitory computer-readable medium of claim 5, wherein the process further comprises:
generating, as a glitch propagation condition, a logical value of an input signal of a reception circuit that receives the output signal including the glitch from the circuit when the reception circuit reflects the received glitch in an output signal of the reception circuit;
determining whether the glitch is propagated to the output signal of the reception circuit on the basis of the generated glitch propagation condition; and
reflecting the glitch in the output signal of the reception circuit when the glitch is propagated from the circuit to the reception circuit.

8. The non-transitory computer-readable medium of claim 5, wherein the process further comprises:
selecting, among the input signals of the circuit, two input signals that does not cause a logical value of the output signal of the circuit to be varied when logical values of the two input signals are simultaneously varied; and
when the logical value of the output signal of the circuit is varied by varying the logical value of one of the selected two input signals in a state in which the logical value of the other of the selected two input signals is fixed, extracting a transition pattern of the one of the selected two input signals as the transition pattern causing the glitch.

9. An power consumption calculation apparatus for calculating power consumption of an integrated circuit on the basis of circuit information representing an internal configuration of each circuit included in the integrated circuit and connection-between-circuits information representing connection between the circuits, the power consumption calculation apparatus comprising a computer configured to execute a process including:
acquiring transition information about an input signal and an output signal of the circuit by performing logical analysis, on the assumption that no propagation delay occurs between the circuits, on the basis of input pattern information including an input signal pattern of the integrated circuit, the connection-between-circuits information, and logical model information about the circuit;
extracting, by the computer, from transition patterns of the input signal of the circuit, a transition pattern causing a glitch in the output signal of the circuit on the basis of the logical model information about the circuit;
reflecting, by the computer, the glitch in the transition information about the output signal of the circuit responsive to the input signal having the extracted transition pattern among the acquired transition information; and
calculating, by the computer, the power consumption of the integrated circuit on the basis of the transition information in which the glitch is reflected.

10. The power consumption calculation apparatus of claim 9, wherein the process further includes:
when a relationship between a logical value of the input signal of the circuit causing the glitch and a logical value of the corresponding output signal of the circuit is not consistent with logic of the circuit, changing the logical value of the input signal of the circuit in a state in which the logic value of the corresponding output signal of the circuit is fixed so that the relationship is consistent with logic of the circuit.

11. The power consumption calculation apparatus of claim 9, wherein the process further includes:
generating, as a glitch propagation condition, a logical value of an input signal of a reception circuit that receives the output signal including the glitch from the circuit when the reception circuit reflects the received glitch in an output signal of the reception circuit;
determining whether the glitch is propagated to the output signal of the reception circuit on the basis of the generated glitch propagation condition; and
reflecting the glitch in the output signal of the reception circuit when the glitch is propagated from the circuit to the reception circuit.

12. The power consumption calculation apparatus of claim 9, wherein the process further includes:
selecting, among the input signals of the circuit, two input signals that does not cause a logical value of the output signal of the circuit to be varied when logical values of the two input signals are simultaneously varied; and
when the logical value of the output signal of the circuit is varied by varying the logical value of one of the selected two input signals in a state in which the logical value of the other of the selected two input signals is fixed, extracting a transition pattern of the one of the selected two input signals as the transition pattern causing the glitch.
